(19) United States
(12) Patent Application Publication
(10) Pub. No.: US 2010/0218651 A1
(43) Pub. Date: Sep. 2, 2010

(54) Conveying Apparatus for Machining Device

(76) Inventor: Ji Yeun Pack, Seoul (KR)

Correspondence Address: THE NATH LAW GROUP, 112 South West Street, Alexandria, VA, 22314, US

(21) Appl. No.: 11/991,645

(22) PCT Filed: Sep. 13, 2006
(86) PCT No.: PCT/KR2006/003634

§ 371 Date: Mar. 7, 2008

(30) Foreign Application Priority Data
Sep. 13, 2005 (KR) 10-2005-0085097

(51) Int. Cl. B23Q 23/00

(52) U.S. Cl. 82/141

(57) ABSTRACT

A conveying apparatus for a machining device of the present invention comprises a base carrying die (10) formed with guide rails (11a) for guiding a machining device straightly in the lengthwise direction; a main screw bar (20) mounted in the base carrying die (10) rotatively; a sub-screw bar (30) rotating in association with the rotation of the main screw bar (20), a pair of engagement gears (40,41) provided on one side of each of the main screw bar (20) and the sub screw bar (30); the turret (50) positioned to the guide rails (11 a) of the base carrying die (10) via engagement with the main screw bar (20) and the sub screw bar (30), wherein the turret (50) has a first coupling hole (51) formed with a first continuous spiral groove (51a) on an inner peripheral surface and a second coupling hole (52) formed with a second continuous spiral groove (52a) on an inner peripheral surface; and a screw rotation element (60) for rotating the main screw bar (20).

### TECHNICAL FIELD

The present invention relates to a conveying apparatus for a machining device, which may prevent shock generated between screw elements and finely control a clearance generated between the screw elements when a moving direction of a moving block is changed.

### BACKGROUND ART

In general, a machining device is to cut an object in contact while conveying a tool fixed on a turret right and left or to and fro. There are lathes, NC (Numerical Control) lathes, drilling machines, boring machines and the like in such machining devices, wherein the lathes are most widely used.

As shown in FIG. 1, such the lathe is mounted with a tail stock 2 which moves along a bed 1, a chuck 3 is mounted at a side of the bed 1 and rotates by rotation force transmitted from a motor, and a turret 4 secures an object thereon.

The turret 4 is mounted to a carriage 5 and moves to and fro to cut off the object fixed to the chuck 3. The tail stock 2 is carried along the bed 1 and supports the center of the object.

The above turret 4 and the tail stock 2 carry out straight reciprocative motion to and fro respectively and move to positions desired by a worker. Such a conveying apparatus, as shown in FIG. 2, includes a base carrying die 10 formed with guide rails 11a in the lengthwise direction, a screw bar 10a having a spiral part 10b formed continuously in a direction on an outer periphery and rotatively mounted on the base carrying die 10, a turret 50 having a coupling hole 50b formed with a continuous spiral groove 50a corresponding to the spiral part 10b on an inner peripheral surface to be spirally coupled with the screw bar 10a, and positioned on the guide rails 11a of the base carrying die 10 to move along the guide rails 11a according to the rotation direction of the screw bar 10a, and a screw rotation element 60 for rotating the screw bar 10a.

A rotation motor 61 is used as an automatic one of such the screw rotation element 60 for generating rotation force by electricity, wherein the worker may control a position of the turret 50 by rotating the screw bar 10a automatically by manipulating a switch.

Further, an engine lathe may include a working handle to be grasped and rotated by the worker for rotating the screw bar 10a with the screw rotation element 60 for conveying the turret 4 manually instead of automatically by the switch manipulation.

The spiral groove 50a of the turret 50 is spirally coupled with the screw bar 10a, as shown in FIG. 3, to move smoothly by the rotation of the screw bar 10a, wherein the spiral groove 50a has a width slightly larger than that of the spiral part 10b of the base carrying die 10 to generate a margin 53 between the spiral groove 50a and the screw bar 10a coupled together.

As the worker supplies electricity to the rotation motor 61 by manipulating the switch, the rotation motor 61 rotates the screw bar 10a and the turret 50 moves straightly along the guide rails 11a so that the object secured on the turret 50 may be moved to a position desired by the worker.

The above conveying apparatus is in a structure not only to move a turret of a machining device but also to move a moving jaw of a vise, and has a block coupled with rails to move horizontally and straightly along the rails via combination of a plurality of shafts. Therefore, the conveying apparatus may be employed in orthogonal coordinate robots or horizontal movement robots forming various module systems in automation facilities.

### DISCLOSURE OF INVENTION

### Technical Problem

The conveying apparatus as above has, however, a disadvantage that the margin formed in the spiral groove of the coupling hole of the turret becomes biased to a side by contact between the spiral part and an inner surface of the spiral groove in a movement direction of the spiral part of the screw bar during the movement of the turret caused by the rotation of the screw bar.

Further, if the turret is carried in an opposite direction, the spiral part of the screw bar moves as much as the space of the margin, which causes a shock by the contact with the inner surface of the spiral groove and this shock generates damages of a bite or an object to be machined.

In particular, when conveying the turret in the opposite direction during high speed movement of the turret, the spiral groove of the turret comes into collision with the spiral part of the screw bar seriously, damaging the tool.

Therefore, when the conveying direction of the turret is changed oppositely in the conveying apparatus, the durability of the conveying apparatus becomes deteriorated by the shock applied to the turret and the tool, increasing a cost for repairing or exchanging the damaged one.

Furthermore, precision of the conveying apparatus becomes another problem.

### Technical Solution

Therefore, the present invention is derived to resolve the above and any other disadvantages of the prior art.

According to the present invention, there is an object to provide a conveying apparatus for a machining device for preventing instant shock between a tool and an object so as to increase durability of the turret and the tool.

The present invention has another object to provide a conveying apparatus for a machining device for improving machining precision of an object.

The present invention has a still another object to provide a conveying apparatus for a machining device for carrying out assembling with a clearance finely controllable between screw elements formed of a pair of right and left spiral parts.

In order to achieve the above objects, according to the present invention, there is provided a conveying apparatus for a machining device, including a base carrying die formed with guide rails for guiding a machining device straightly in the lengthwise direction, a main screw bar mounted in the base carrying die rotatively and formed with a first spiral part continued in a direction on an outer peripheral surface, a sub screw bar formed with a second spiral part continued in the opposite direction from the first spiral part of the main screw bar and rotating in association with the rotation of the main screw bar, a pair of engagement gears provided on one side of each of the main screw bar and the sub screw bar for transmitting rotation force of the main screw bar to the sub screw bar, a turret positioned to the guide rails of the base carrying die via engagement with the main screw bar and the sub screw bar to move along the guide rails according to the rotation direction of the main screw bar and the sub screw bar, wherein the turret has a first coupling hole formed with a first continuous spiral groove on an inner peripheral surface to be coupled with the first spiral part of the main screw bar and a second coupling hole formed with a second continuous spiral groove on an inner peripheral surface to be coupled with the second spiral part of the sub screw bar, and a screw rotation element for rotating the main screw bar.

### ADVANTAGEOUS EFFECTS

According to the present invention, the instant shock is not generated between a machining device and an object when changing conveying direction of a turret, so that damages of the machining device and the object possibly generated by the shock may be prevented in advance.

Further, when changing advancing direction of the turret, the instant shock possibly generated by a clearance between spiral parts may be finely controlled in the process of assembling, so that the change of the advancing direction for the turret may be realized naturally and smoothly.

Therefore, each structure around the turret as well as the object may be expanded in their lifespan. Further, the workability and the manipulation thereof in use may be improved noticeably.

### BRIEF DESCRIPTION OF THE DRAWINGS

FIG. 1 is a schematic view showing a prior art lathe;

FIG. 2 is a cross-sectional view showing a prior art conveying apparatus for a machining device;

FIG. 3 is an expanded view showing a principal part “A” of FIG. 2;

FIG. 4 is a cross-sectional view showing a conveying apparatus for a machining device according to a preferred embodiment of the present invention;

FIG. 5 is an expanded view showing a principal part “B” of FIG. 4; and

FIG. 6 is an expanded view showing a principal part “C” of FIG. 4.

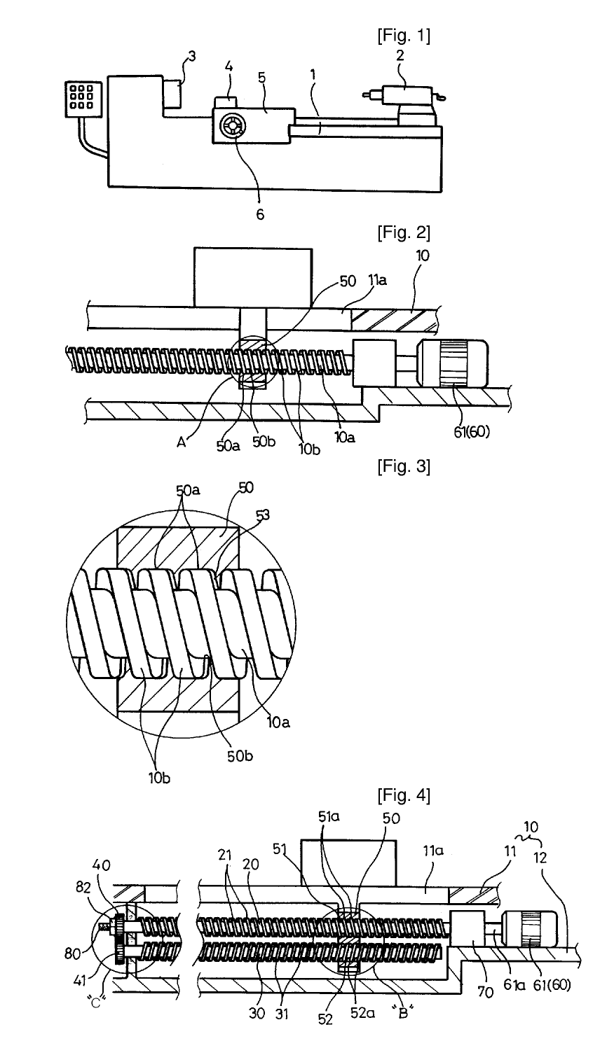

### BEST MODE FOR CARRYING OUT THE INVENTION

At least one of the main screw bar and the sub screw bar is integrally formed with a bolt part at an axial end, a corresponding one of the engagement gears is formed with a spiral hole to be coupled with the bolt part, and a lock nut is coupled outside the engagement between the bolt part and the spiral hole.

Therefore, the turret is spirally coupled with the main screw bar and the sub screw bar penetratingly, so that the main screw bar supports forward movement of the turret and the sub screw bar supports inverse movement of the turret. Therefore, shock may be prevented between an object to be machined and a tool caused by a spiral gap even when the movement direction of the turret is changed inversely.

When assembling the turret simultaneously coupled with the two screw bars of the main screw bar and the sub screw bar in different direction, a clearance generated in the engagement between the main and sub screw bars and the turret may be finely controlled by the bolt part, which is formed at the axial end, so that the shock generated between the object and the tool may be minimized during the reciprocation of the turret.

Now, a preferred embodiment of the present invention will be described in detail with reference to the accompanying drawings.

FIG. 4 is a cross sectional view showing a conveying apparatus for a machining device, wherein a base carrying die is mounted with a main screw bar and a sub screw bar, wherein the turret is coupled with the base carrying die by both of the main screw bar and the sub screws bar.

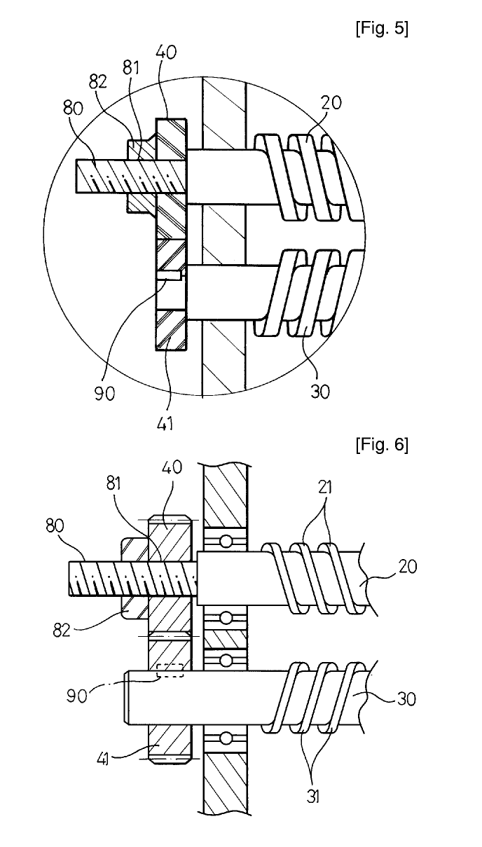

FIG. 5 is an expanded view of part “B” of FIG. 3, wherein the main screw bar is in close contact with a side of a first spiral groove at its first spiral part for supporting forward movement of the turret, and the sub screw bar is in close contact with a side of a second spiral groove at its second spiral part for supporting inverse movement of the turret.

FIG. 6 is an expanded cross-sectional view of part “C” of FIG. 4, wherein a bolt part is extendedly formed at an axial end of the main screw bar to be spirally coupled in a screw hole formed in one of engagement gears, and a lock nut is coupled outside the coupling between the bolt part and the screw hole for preventing release.

Referring to FIG. 4, a conveying apparatus for a machining device according to the present invention includes a base carrying die 10 having rail parts 11 formed with guide rails 11a at top parts thereof and a supporting part 12 for supporting a screw rotation element, which is described hereinafter, at a lower part.

The base carrying die 10 is positioned with a turret 50 at its guide rails 11a of the rail parts 11, so that the base carrying die 10 guides rectilinear reciprocation motion of the turret 50, wherein the base carrying die 10 has a length enough to move the turret 50.

A mounting space part 13 of the base carrying die 10 is formed between the rail parts 11 and the supporting part 12 for mounting a main screw bar 20 and a sub screw bar 30.

The mounting space part 13 of the base carrying die 10 is mounted with the main screw bar 20 and the sub screw bar 30 rotatively, wherein the sub screw bar 30 is mounted with a distance from the main screw bar 20 below the main screw bar 20.

The main screw bar 20 and the sub screw bar 30 are connected to each other via a rotation force transmission element 40 and mounted in the mounting space part 13 of the base carrying die 10, so that the sub screw bar 30 rotates in the engagement direction with the main screw bar 20 as the main screw bar 20 rotates.

The main screw bar 20 and the sub screw bar 30 are respectively formed with first and second spiral parts 21, 31, which are respectively formed in opposite direction to each other, that is, in the right and left directions respectively.

The rotation force transmission element 40 has a driving gear 41 fixed to an end of the main screw bar 20 and a driven gear 42 fixed at an end of the sub screw bar 30, wherein the driven gear 42 is engaged with the driving gear 41.

When the main screw bar 20 rotates by a screw rotation element 60, which is described below, the rotation force of the screw main screw bar 20 rotates the sub screw bar 30 in the opposite direction of the main screw bar 20 via the driven gear 42 engaged with the driving gear 41. Therefore, the second spiral part 31 of the sub screw bar 30 is formed in the opposite direction with the first spiral part 21 of the main screw bar 20.

The main screw bar 20 and the sub screw bar 30 are coupled with the turret 50 that moves to and fro straightly by the rotation of the main screw bar 20 and the sub screw bar 30.

The turret 50 has a first coupling hole 51 formed with a first continuous spiral groove 51a on its inner surface, with which the first spiral part 21 is coupled, and a second coupling hole 52 formed with a second spiral groove 52a on its inner surface, with which the second spiral part 31 is coupled.

The first and second spiral grooves 51a, 52a formed to the first and second coupling holes 51, 52 of the turret 50 inevitably have margins 53 serving as clearances required for spiral rotation of the first and second spiral parts 21, 31 while the first and second spiral parts 21, 31 are coupled therewith, thereby making straight movement of the turret 50 smoothly.

When the turret 50 is spirally coupled with the main screw bar 20 and the sub screw bar 30 via the first and second coupling holes 51, 52, the first spiral part 21 becomes closely contacting the first spiral groove 51a in the forward direction in the movement of the turret 50, forming the margin 53 in the opposite direction and the second spiral part 31 becomes closely contacting the second spiral groove 52a in the inverse direction in the movement of the turret 50, forming the margin 53 in the opposite direction.

The main screw bar 20 is provided with the screw rotation element 60, which generates rotation force for rotating the main screw bar 20.

The screw rotation element 60 is to be a rotation motor 61, which is fixed to a side of the supporting part 12 of the base carrying die 10 at an end for rotating the main screw bar 20 by electricity. Even though it is not shown in the drawings, a working handle may be provided for a user to grasp to rotate the main screw bar 20.

The rotation motor 61 has a shaft 61a for generating the rotation force, wherein the shaft 61a is connected to the main screw bar 20 via a gear box 70.

As a worker manipulates a switch for rotating the rotation motor 61 in the forward direction by supplying electricity, the rotation motor 61 rotates the main screw bar 20 in the forward direction. The rotation force of the main screw bar 20 is transmitted to the sub screw bar 30 via the rotation force transmission element 40.

As the main screw bar 20 and the sub screw bar 30 rotate, the first spiral part 21 of the main screw bar 20, which is in close contact with the first spiral groove 51a, pushes the turret 50, so that the base carrying die 10 moves straightly along the guide rails 11a in the forward direction.

If the rotation motor 61 is driven in the opposite direction for rotating the main screw bar 20 in the reverse direction, the main screw bar 20 and the sub screw bar 30 rotate in the reverse direction and the second spiral part 31 of the sub main screw bar 30, which is in close contact with the second spiral groove 52a, pushes the turret 50, so that the turret 50 moves straightly along the guide rails 11a the base carrying die 10 in the reverse direction.

Therefore, the margins 53 are formed between the first and second spiral parts 21, 31 in the opposite direction even when the rotation direction of the turret 50 is changed by the forward and reverse rotation of the main screw bar 20 carried out via the screw rotation element 60, so that a clearance is not generated even when changing the direction instantly, thereby preventing the generation of the instant shock between a tool such as a bite and an object to be machined.

The conveying apparatus for a machining device of the present invention as described hereinabove may be employed not only in the structure used for conveying a turret of the machining device but also conveying a moving jaw of a vise.

Further, the conveying apparatus of the present invention as above may be utilized in any rectilinear movement via the turret 50. The present invention may be applied to orthogonal coordinate robots with a plurality of combined shafts or horizontal movement robots forming various module systems used in automation facilities, wherein a block is coupled with the rails to move straightly and horizontally along the rails. Such a structure is also included in the gist of the present invention.

In the meantime, when the main screw bar 20 and the sub screw bar 30 formed with the spiral parts in the different directions are coupled with the turret 50 simultaneously, it is difficult to assemble the main screw bar 20 and the sub screw bar 30 to the turret 50 without any clearance in the engagement advancing direction, that is, in the opposite directions of the margins 53.

Therefore, it is required an element for finely controlling the clearance in the positions of the engagement gears 40, 41 while the engagement gears 40, 41 for transmitting the rotation force in the engagement direction between the main screw bar 20 and the sub screw bar 30.

As shown in FIG. 6, a bolt part 80 is integrally formed to an axial end of the main screw bar 20 and a female spiral hole 81 is machined to the engagement gear 40, so that the bolt part 80 and the female spiral hole 81 are engaged with each other and coupled spirally.

Further, a lock nut 82 is coupled outside the engagement between the bolt part 80 and the female spiral hole 81 for preventing release therebetween in operation.

Even though the bolt part 80 and the female spiral hole 81 are formed to the main screw bar 20 in the accompanying drawings, the same structure may be realized in the sub screw bar 30.

As described hereinabove, if the bolt part 80 and the female spiral hole 81 are formed to the positions of the engagement gears 40, 41, which transmit the rotation force in the engagement direction between the main screw bar 20 and the sub screw bar 30, the lock nut 82 may finely control the main screw bar 20 and the sub screw bar 30 not to generate a clearance between contact surfaces of the spiral parts, which operate the turret 50 in the advancing direction. Therefore, the turret 50 may reciprocate right and left repeatedly via the change of advancing direction carried out in a short time without any clearance.

The sub screw 30, which is not formed with the female spiral hole 81, and the engagement gear 41 are coupled with each other by a key 90 for preventing idling each other.

### INDUSTRIAL APPLICABILITY

The present invention may be applied to orthogonal coordinate robots with a plurality of combined shafts or horizontal movement robots forming various module systems used in automation facilities, wherein a block is coupled with the rails to move straightly and horizontally along the rails. Such a structure is also included in the gist of the present invention.

1. A conveyor apparatus for a machining device, comprising:
a base carrying die formed with guide rails for guiding a machining device straightly in the lengthwise direction;
a main screw bar mounted in the base carrying die rotatively and formed with a first spiral part continued in a direction on an outer peripheral surface;
a sub screw bar formed with a second spiral part continued in the opposite direction from the first spiral part and rotating in association with the rotation of the main screw bar;
a pair of engagement gears provided on one side of each of the main screw bar and the sub screw bar for transmitting rotation force from the main screw bar to the sub screw bar;
the turret positioned to the guide rails of the base carrying die via engagement with the main screw bar and the sub screw bar to move along the guide rails according to the rotation direction of the screw bars, wherein the turret has a first coupling hole formed with a first continuous spiral groove on an inner peripheral surface to be coupled with the first spiral part and a second coupling hole formed with a second continuous spiral groove on an inner peripheral surface to be coupled with the second spiral part; and
a screw rotation element for rotating the main screw bar.

2. The conveying apparatus according to claim 1, wherein at least one of the main screw bar and the sub screw bar is formed with a bolt part integrally at an axial end and one of the engagement gears is formed with a screw hole to be spirally coupled with the bolt bar, wherein a lock nut is coupled outside the coupling between the bolt part and the screw hole.

3. The conveying apparatus according to claim 2, wherein the bolt part is respectively formed on both of the main screw bar and the sub screw bar, and the screw hole is respectively formed on both of the engagement gears.
